(19) United States
(12) Patent Application Publication
(10) Pub. No.: US 2019/0111376 A1
(43) Pub. Date: Apr. 18, 2019

(54) MATCHING OF RESTRICTORS AND SEPARATION COLUMNS

(71) Applicant: Waters Technologies Corporation, Milford, MA (US)

(72) Inventors: Michael O. Fogwill, South Grafton, MA (US); James P. Murphy, Franklin, MA (US); Geoff C. Gerhardt, Woonsocket, RI (US)

(73) Assignee: Waters Technologies Corporation, Milford, MA (US)

(21) Appl. No.: 16/157,921

(22) Filed: Oct. 11, 2018

Related U.S. Application Data
(60) Provisional application No. 62/571,539, filed on Oct. 12, 2017.

(51) Int. Cl. B01D 53/02

(52) U.S. Cl. CPC B01D 53/025

(57) ABSTRACT

The present disclosure relates to methodologies, systems, apparatus, kits, and microfluidic separation devices based on separation columns and restrictors that are matched and bundled together for distribution as a unit, where the mobile phase flow rate and post-column pressure are specified based on this combination of matched separation column and restrictor.

### RELATED APPLICATION

This application claims priority to U.S. Provisional Application No. 62/571,539, filed on Oct. 12, 2017, which is incorporated herein by reference in its entirety.

### BACKGROUND

Chromatography involves the flowing of a mobile phase over a stationary phase to effect separation. To speed-up and enhance the efficiency of the separation, pressurized mobile phases are introduced. Carbon dioxide based chromatographic systems use CO₂ as a component of the mobile phase flow stream, and the CO₂ based mobile phase is delivered from pumps and carried through the separation column as a pressurized fluid. The CO₂ based mobile phase is used to carry components of the analytes in a sample through the chromatography column to the detection system.

Chromatography systems often use a restrictor to interface to the detection system or to control system pressure. The restrictor can be used to maintain system pressure and introduce a portion of the mobile phase flow to the detection system.

### SUMMARY

A restrictor can provide a cost-effective method of controlling back pressure in a chromatography. However, the restrictor may be incapable of adapting to large changes in mobile phase composition, mobile phase flow rate, or post-column pressure. A pressure-controlling fluid interface may be used to compensate for changes in the mobile phase composition, but the pressure-controlling fluid may not able to adapt to changes in the mobile phase flow rate or post-separation column pressure. This inability to compensate can result in diminished performance and sensitivity of the chromatography system.

Example systems, methodologies, apparatus and kits herein provide for matching of the restrictor to separation column, and determining the mobile phase flow rate and post-column pressure that works optimally with this matched combination. As a result, the combination of matched separation column and restrictor can be implemented in a chromatography system and cause it to operate with optimal sensitivity.

For example, for a chromatography system that employs a pressure-controlling fluid interface, the example systems, methodologies, and apparatus herein provide for matching the separation column with the restrictor, and specifying the mobile phase flow rate and post-column pressure that optimizes performance of the chromatography system with this matched combination. Example kits are also provided that includes the matched restrictor and separation column, packaged together with at least one processing unit as a bundle, where the at least one processing unit is configured to execute processor-executable instructions to transmit an indication of the values of mobile phase flow rate and post-column pressure that optimizes performance of the chromatography system with this matched combination.

Example integrated microfluidic separation devices are also provided that are based on a separation columns matched with restrictors.

In one aspect, the present technology provides a method for configuring a chromatography system with independent control of system pressure and flow rate of a carbon dioxide-based mobile phase flow stream. This method includes determining a type of chromatography separation column to be used in the chromatography system; determining an operative value of a mobile phase flow rate of the CO₂-based mobile phase flow stream that corresponds to the chromatography separation column; determining a matching restrictor to the type of chromatography separation column for use together during operation of the chromatography system, the matching restrictor being configured such that a post-column pressure in the chromatography system during operation is maintained at a target pressure at the operative value of the mobile phase flow rate; and bundling the chromatography separation column with its matching restrictor for distribution together as a single unit.

Embodiments of this aspect can include one or more of the following features. In certain embodiments, the target pressure is set to or above 1800 PSI. In some embodiments, the chromatography system includes a pressure-controlling interface. The pressure-controlling interface can interface to a low-pressure detector (e.g., MS detector, FID, etc.). In certain embodiments which include the pressure-controlling interface, the target pressure is set as the lowest initial pressure of the chromatography system. In certain embodiments, the method includes that the matching restrictor is configured such that a post-column pressure in the chromatography system during operation is a value above which the CO₂-based mobile phase flow stream is in a relatively incompressible state (e.g., the density of the CO₂ does not fluctuate greatly over small changes in temperature or pressure). The CO₂-based mobile phase flow stream can include one or more modifiers or additives. In certain embodiments, in which a modifier is present, the matching restrictor provides an outlet pressure ranging from about 10% to about 20% lower than a target value of post-column pressure at a designated proportion of the modifier to the CO₂-based mobile phase flow stream (e.g., about 30% when the modifier is methanol). In certain embodiments, the method includes that the matching restrictor is configured such that a post-column pressure in the chromatography system during operation is a value above which the CO₂ and the modifier and/or additive components of the CO₂-based mobile phase are completely miscible.

Another aspect of the technology is directed to a kit for a chromatography system with independent control of system pressure and flow rate of a CO₂-based mobile phase flow stream. The kit includes: a chromatography separation column configured to be used in the chromatography system at an operative value of a mobile phase flow rate of the CO₂-based mobile phase flow stream; a restrictor matched to the type of chromatography separation column for use together during operation of the chromatography system, the restrictor being configured such that a post-column pressure in the chromatography system during operation is maintained at a target pressure at the operative value of the mobile phase flow rate; and at least one processing unit configured to execute processor-executable instructions to transmit to a user, or to display to a display unit, data indicative of the operative value of the mobile phase flow rate of the CO₂-based mobile phase flow stream that corresponds to the chromatography separation column and the target pressure.

Embodiments of this aspect of the technology can include one or more of the following features. In some embodiments, the processing unit is configured to execute processor-executable instructions to cause the chromatography system to maintain the post-column pressure at the target pressure during operation. In certain embodiments, the target pressure is set to above about 1800 PSI (e.g., 1900 PSI, 2000 PSI 2100 PSI). In certain embodiments, the restrictor is configured such that a post-column pressure in the chromatography system during operation is a value above which the CO₂-based mobile phase flow stream is in a relatively incompressible state. In some embodiments, the processing unit is configured to execute processor-executable instructions to cause the post-column pressure in the chromatography system during operation is a value above which the CO₂-based mobile phase flow stream is in a relatively incompressible state. In some embodiments, the processing unit is configured to execute instructions to cause the CO₂-based mobile phase flow stream to flow at the specified value of the mobile phase flow stream. In some embodiments, the mobile phase includes one or more modifiers and/or one or more additives. In an embodiment which includes a methanol modifier, the restrictor can be configured to provide an outlet pressure ranging from about 10% to about 20% lower than a target value of a post-column pressure at a proportion of about 30% of the modifier to the CO₂-based mobile phase flow stream. In other embodiments which include a modifier and/or additive, the restrictor can be configured such that a post-column pressure in the chromatography system during operation is a value above which the CO₂ and the modifier and/or additive components of the CO₂-based mobile phase are completely miscible. In some embodiments, the kits further include at least one memory to store the processor-executable instructions, wherein the at least one processing unit is communicatively coupled to the at least one memory.

In another aspect, the technology features an integrated microfluidic separation device. The device includes a chromatography system with independent control of system pressure and flow rate of a CO₂-based mobile phase flow stream. The device further includes: a chromatography separation column; a restrictive element matched to the type of the chromatography separation column, the restrictor being configured such that a post-column pressure in the chromatography system during operation is maintained at a target pressure at the operative value of the mobile phase; and at least one processing unit configured to execute processor-executable instructions to transmit to a user, or display to a display unit, data indicative of the value of target pressure and a specified value of a mobile phase flow rate of the CO₂-based mobile phase flow stream that corresponds to the chromatography separation column. In some embodiments, the device further includes at least one memory to store the processor-executable instructions, the memory being coupled to the processing unit. Certain embodiments also include an interface to a low-pressure detector. Embodiments can feature automated control and regulation. For example, in some embodiments, the device may include more than one restrictive element. In such embodiments, the device can determine the identify of each restrictive element and make the calculations for each restrictive element. Further, the device can include regulators that will automatedly set conditions such as flow rate and pressure, such that the target pressure can be maintained automatically without user involvement.

The above systems, methodologies, apparatus and kits provide numerous advantages. For example, by providing a matched combination of one or more restrictor, pressures and flow rates across one or more column dimensions in a SFC or other pressure-controlling fluid system leads to increased detector sensitivity over conventional systems. In addition to increased sensitivity, certain embodiments of the present technology provide the advantage of reduced setup time and elimination or minimization of optimization time for a column change or change in dimension of a column within a system. This is because, the column, restrictor, and flow rates are matched and pre-packaged, eliminating optimization steps. Further, some embodiments provide for increased usability as optimization steps after a column change can be eliminated.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

One of ordinary skill in the art will understand that the drawings primarily are for illustrative purposes and are not intended to limit the scope of the inventive subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

FIGS. 1A-1B show flowcharts of example methodologies, according to principles of the present disclosure.

FIG. 2 shows an example apparatus that can be used to perform example processes and computations, according to principles of the present disclosure.

FIGS. 3A-3B show block diagrams illustrating example CO₂-based chromatography systems, according to principles of the present disclosure.

FIG. 4 shows an example microfluidic separation device, according to principles of the present disclosure.

FIGS. 5-7 show block diagrams illustrating example CO₂-based chromatography systems, according to principles of the present disclosure.

FIG. 8 shows a diagram of an example network environment suitable for a distributed implementation, according to principles of the present disclosure.

FIG. 9 shows a block diagram of an example computing device that can be used to perform example processes and computations, according to principles of the present disclosure.

The features and advantages of the present disclosure will become more apparent from the detailed description set forth below when taken in conjunction with the drawings.

### DETAILED DESCRIPTION

Following below are more detailed descriptions of various concepts related to, and embodiments of, methodologies, apparatus and systems for matching of the restrictor to separation column, and determining the mobile phase flow rate and post-column pressure that works optimally with this matched combination. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means includes but is not limited to, the term “including” means including but not limited to. The term “based on” means based at least in part on.

A “restrictor” herein refers to a component used in a chromatography system that is used to restrict mobile phase flow and control system pressure. A restrictor may be used to interface to a detection component. Non-limiting examples of restrictors include a length of straight, small internal diameter tubing, a tapered restrictor, a converging-diverging restrictor, an integral restrictor, a fritted restrictor, or a thermally modulated variable restrictor.

Chromatography systems are widely used for separating a sample including analytes into its constituents. Due to their low cost and ease of manufacture, restrictors are implemented in many types of chromatography systems. The restrictor can be used to maintain system pressure in the chromatography system and to introduce a portion of the mobile phase flow to a detector. For example, the restrictor can be used to control the interface to a low-pressure detection component, such as but not limited to a mass spectrometry (MS) detection system, an evaporative light scattering detection system, or a flame ionization (FID) detection system.

Restrictors can fail through several different types of mechanisms. For example, a failure mechanism can result from a solid particle becoming lodged into the restrictor orifice, causing complete blockage. A failed restrictor according to this failure mechanism can be easy to diagnose. Since very little or no fluid would exit this failed restrictor, the detector response would be very low, or the chromatography system would exhibit very high or uncontrolled pressures. As another example, a second type of failure mode can result from increasing analyte or matrix deposits on the interior walls of the restrictor, causing a change in the restriction performance of the restrictor, but not a complete obstruction. Also, precipitated particles from the fluid may cause plugging of the restrictor. These modes may be more difficult to diagnose.

Replacement of a restrictor in a chromatography system can be a time-consuming process. For example, unless the replacement restrictor is matched to the separation column, a time-consuming calibration process may be required to optimize the performance of the chromatography system.

In an example chromatography system that includes a pressure-controlling fluid interface, a restrictor provides a simple, cost-effective method of providing back pressure. However, a fixed restrictor can be less capable of adapting to large changes in mobile phase composition, mobile phase flow rate, or post-column pressure. Use of a pressure-controlling fluid interface can compensate for changes in mobile phase composition, but the chromatography system may not be able to adapt to changes in mobile phase flow rate or post-column pressure.

Example systems, methodologies, apparatus and kits according to the principles herein can be used to match the restrictor of a chromatography system to the separation column, and specify the mobile phase flow rate and post-column pressure that works optimally with this matched restrictor-column combination. The resulting chromatography system, including the matched combination, operates with optimal sensitivity at the specified mobile phase flow rate and post-column pressure. The example systems, methodologies, and apparatus are applicable to an example chromatography system that employs a pressure-controlling fluid interface.

A chromatography system can exhibit poor sensitivity in detection if the target pressure differs greatly from the restrictor pressure. Therefore, a lengthy optimization process generally needs to be undertaken whenever a restrictor or separation column is changed. Example systems, methodologies, and apparatus according to the principles herein eliminate the need for a lengthy optimization process by providing kits including restrictor(s) matched to a separation column and package together with specifications for the optimal mobile phase flow rate for a chromatography system using the packaged components.

When operating a chromatography system with a pressure controlling fluid interface (including a supercritical fluid chromatography system), the performance is optimized if the restrictor is matched quite closely to a desired mobile phase flow rate and post-column pressure. Where these parameters are not well matched, detection sensitivity suffers greatly. Therefore, in order to ensure optimal sensitivity of the chromatography system, and to reduce the setup and optimization time by a user, the separation column, mobile phase flow rate, restrictor, and post-column pressure should be linked.

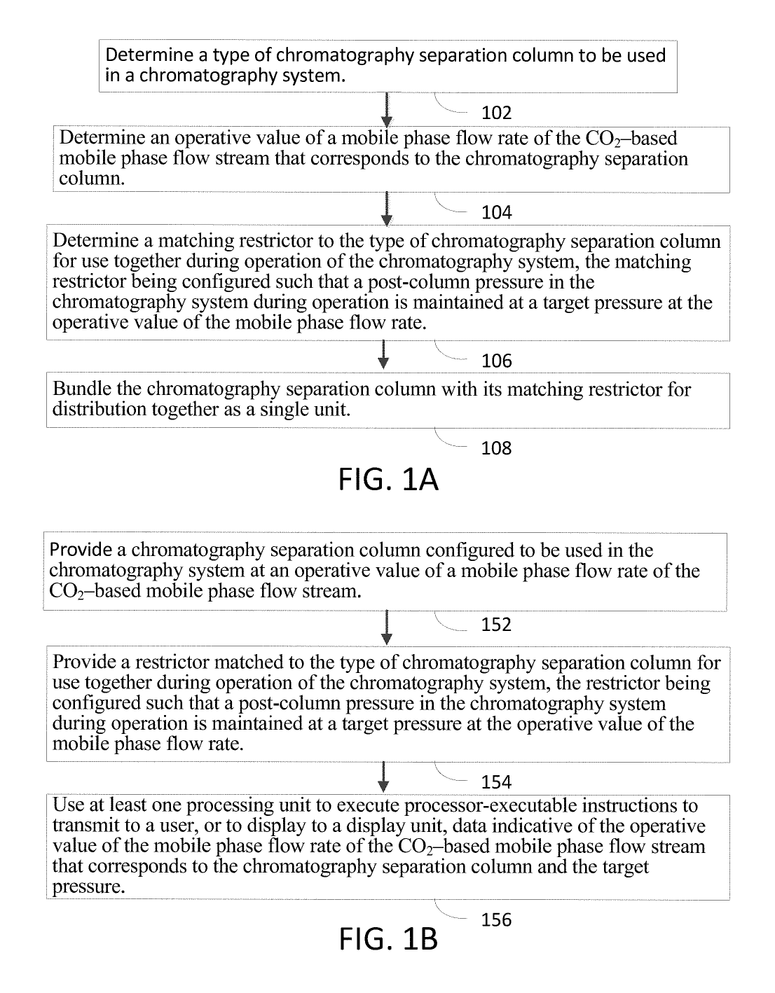

Non-limiting example systems, methodologies, and apparatus described herein can be used for configuring a chromatography system with independent control of system pressure and flow rate of a carbon dioxide (CO₂)-based mobile phase flow stream. FIG. 1A shows a flowchart of an example method for matching the restrictor of the chromatography system to the separation column. As shown in block 102, the type (e.g., size, dimension, packing material particle dimension, etc) of chromatography separation column to be used in the chromatography system is determined. As shown in block 104, an operative value of the mobile phase flow rate of the CO₂-based mobile phase flow stream is determined that corresponds to the chromatography separation column. Based on the data from blocks 102 and 104, the matching restrictor to the type of chromatography separation column that is to be used together during operation of the chromatography system is determined in block 106. In an example, the matching restrictor is configured such that the post-column pressure in the chromatography system during operation is maintained at a target pressure at the operative value of the mobile phase flow rate. As shown in block 108, the chromatography separation column is bundled with the matching restrictor for implementation (including for distribution) together as a single unit.

According to block 102, the type of the chromatography separation column to be used in the chromatography system is determined. The type of chromatography column can be determined based on parameters such as its dimensions (internal diameter and length) and the packing material details such as particle diameter. As a non-limiting example, the separation column can be a conventional packed column having internal diameter (or other such cross sectional length) ranging from about 2.0 mm to about 4.6 mm, and a length ranging from about 0.03 m to about 0.25 m. As another non-limiting example, the separation column can be a microbore packed column, having an internal diameter ranging from about 0.5 mm to about 2.0 mm, and a length ranging from about 0.03 m to about 0.25 m. As yet another non-limiting example, the separation column can be a packed capillary column, having an internal diameter ranging from about 0.1 mm to about 0.5 mm, and a length ranging from about 0.05 m to about 0.5 m. The packed columns can contain packing media ranging from about 1.5 microns to about 10 microns. As yet another non-limiting example, the separation column can be an open tubular column, having an internal diameter ranging from about 0.025 mm to about 0.1 mm, and a length ranging from about 1.0 m to about 35 m. The volumetric pumping speeds and/or volumetric flow rates compatible with the detectors can affect the choice of column type (such as choosing but not limited to a microbore packed column). Packed capillary columns allow for lower volumetric flow rates, can be compatible with mass flow sensitive detectors, and allow for smaller elution peak. The choice of an open tubular column type can result in a compromise between efficiency and speed. Choice of the separation column provides for well-deactivated surfaces and stationary phases, uniform stationary phase films, and well-immobilized stationary phase films.

In block 104, an operative value of the mobile phase flow rate of the CO₂-based mobile phase flow stream is determined that corresponds to the type of the chromatography separation column selected. In non-limiting examples, the operative value of the mobile phase flow rate can be determined as either a value of mobile phase flow rate that causes the chromatography system to stay below a maximum system pressure, or a value of mobile phase flow rate that maximizes the separation efficiency of the chromatography system.

According to block 106, the restrictor is matched to the type of chromatography separation column for use together during operation of the chromatography system. The matching restrictor is configured such that the post-column pressure in the chromatography system during operation is maintained at a target pressure at the operative value of the mobile phase flow rate. In a non-limiting example, the target pressure can be above about 1800 PSI.

According to the principles herein, the column dimensions can indicate the operative range of values of the mobile phase flow rate. The restrictor should be matched to the mobile phase flow rate such that the post-column pressure is set to a value above which the fluid is in its relatively incompressible state, such as but not limited to a value of target pressure above about 2000 PSI. Further, a target pressure of about 2000 PSIi can be sufficient to ensure good miscibility between the mobile phase and any liquid co-solvent (described as a secondary fluid hereinbelow). The restrictor can be matched to the operative value of the mobile phase flow rate such that it provides about 10% lower pressure than the target post-column pressure (such as but not limited to a value of about 1800 PSI) at about 30% modifier, a composition that can provide the highest pack pressure in a CO₂-based mobile phase flow stream employing a methanol modifier. Setting the pressure at about 10% below the target pressure allows for a pressure-controlling fluid pump to bring the pressure up to a target pressure, while introducing a desirable amount of the pressure-controlling fluid. Any more or less of the pressure-controlling fluid flow can result in reduced sensitivity. In this manner, the matching restrictors, target pressures, and operative value of the mobile phase flow rates can be matched and packaged across each separation column dimension.

In an example chromatography system, the restrictor can be disposed on the downstream side of the separation column, to maintain the desired pressure conditions in the chromatographic column. The amount of restriction that a restrictor can provide can be determined by the ratio (aspect ratio) of the length to the internal diameter of the restrictor.

As a non-limiting example, the restrictor can be a fixed restrictor. Non-limiting example morphologies of restrictors include linear restrictors, tapered restrictors, converging-diverging restrictors, pinhole (integral) restrictors, and pinched restrictors. An example linear restrictor can be formed with a small internal diameter, such as but not limited to on the order of tens of microns. An example tapered restrictor has a drawn out portion at an end of the restrictor column. Restrictor types such as the converging-diverging restrictor, pinhole (integral) restrictor, and pinched restrictor present small orifices. In any example herein, the restrictor can be formed from fused silica tubing.

In any example of FIG. 1A, the chromatography system can include a pressure-controlling fluid interface. In such an example where the chromatography system is a pure-CO₂ pressure-programmed gradient system or a density-programmed gradient system, the target pressure can be determined is the lowest initial pressure of the chromatography system.

In a non-limiting example of FIG. 1A where the chromatograph system includes a split-flow interface, the chromatography system can include a pressure-controlling component that is a backpressure regulator (BPR). The restrictor is coupled to a leg of the split-flow interface. The flow rate can be measured as a BPR flow rate of the CO₂-based mobile phase through the backpressure regulator during operation of the chromatography system at a specified pressure and/or at a specified composition.

In any example of FIG. 1A, the flow rate can be measured as a mass flow rate or a volumetric flow rate.

The mobile phase flow stream can employ a single fluid or a be a mixed mobile phase. In an example, the mobile phase fluid is CO₂-based mobile phase, due to its low critical temperature, relative inertness, low toxicity, and non-flammability. In other examples, the mobile phase fluid can include CO, N₂O, ammonia, sulfur dioxide, or freon. In an example, the mobile phase can be a mixed mobile phase, such as but not limited to a mobile phase that includes an added proportion of a secondary fluid. Non-limiting examples of a secondary fluid include a modifier (such as but not limited to a polar organic modifier), a ternary additive, or other material. For example, the CO₂-based mobile phase flow stream can further includes a modifier, a ternary additive, or a combination of one or more modifiers and one or more ternary additives.

The proportion of an added secondary fluid can be considered in determining the matching restrictor. For example, the matching restrictor can be configured such that a post-column pressure in the chromatography system during operation is a value above which the CO₂-based mobile phase flow stream is in a relatively incompressible state. In a non-limiting example, the CO₂-based mobile phase flow stream provides for a specified threshold CO₂-modifier miscibility. The specified threshold miscibility can be a value that indicates good CO₂-modifier miscibility. For example, in a binary phase diagram (two fluids), there exists a region defined by temperatures and pressures where the two fluids are immiscible. This boundary changes with the mass fraction between the two fluids, and can be encountered in chromatography at low pressures and high temperature. As a non-limiting example, for 10% methanol in a CO₂-based mobile phase, the two fluids are immiscible at a pressure of about 1500 PSIi and a temperature of about 60° C. The specified threshold CO₂-modifier miscibility can be achieved in regions of the binary phase diagram outside this boundary (such as but not limited to by increasing the pressure). For example, for the miscibility of the 10% methanol in the CO₂-based mobile phase can be restored by increasing the pressure.

In another non-limiting example, where the CO₂-based mobile phase flow stream includes a methanol modifier, the matching restrictor can be chosen to provide an outlet pressure ranging from about 10% to about 20% lower than a target value of a post-column pressure at a proportion of about 30% of the modifier to the CO₂-based mobile phase flow stream.

In a further non-limiting example, where the CO₂-based mobile phase flow stream includes modifier and/or one or more additives, the matching restrictor is configured such that a post-column pressure in the chromatography system during operation is a value above which the CO₂ and the modifier and/or additive components of the CO₂-based mobile phase are completely miscible.

FIG. 1B shows a flowchart of an example methodology for using a separation column and matching restrictor in a chromatography system according to the principles herein. As shown in block 152, a chromatography separation column is provided that is configured to be used in the chromatography system at an operative value of a mobile phase flow rate of the CO₂-based mobile phase flow stream. As shown in block 154, a restrictor matched to the type of chromatography separation column is provided for use together during operation of the chromatography system. The restrictor is configured such that a post-column pressure in the chromatography system during operation is maintained at a target pressure at the operative value of the mobile phase flow rate. As shown in block 156, at least one processing unit is used to execute processor-executable instructions to transmit to a user, or to display to a display unit, data indicative of the operative value of the mobile phase flow rate of the CO₂-based mobile phase flow stream that corresponds to the chromatography separation column and the target pressure. Based on the transmitted or displayed data, a user is able to operate the chromatography system with the separation column and matching restrictor for optimal measurement sensitivity.

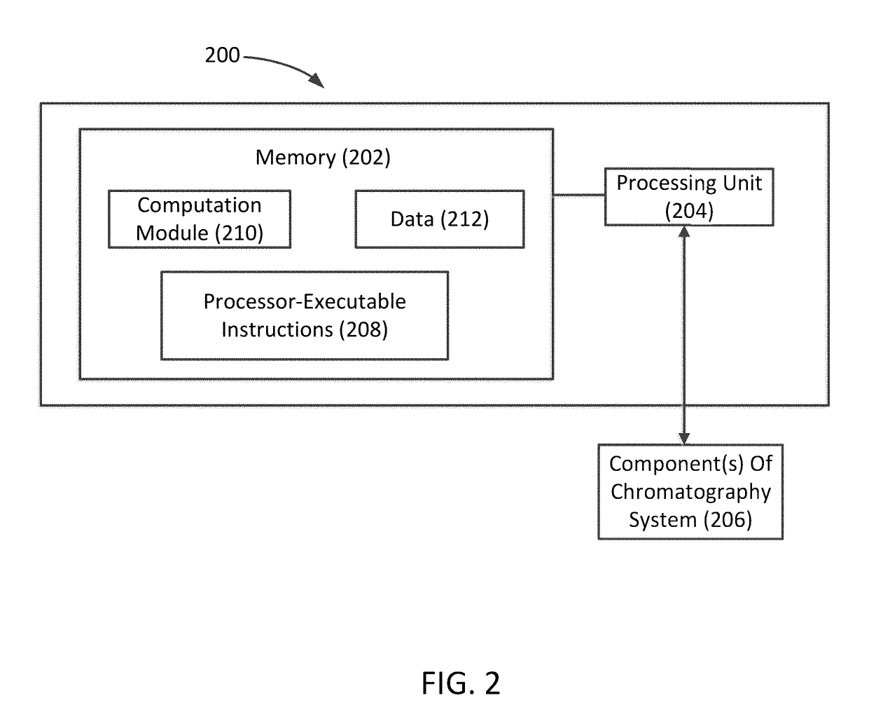

FIG. 2 shows a non-limiting example apparatus 200 that can be used to implement an example method in a chromatography system with independent control of system pressure and flow rate of a carbon dioxide (CO₂)-based mobile phase flow stream, using a chromatography separation column and matching restrictor according to the principles described herein.

The example chromatography system includes a chromatography separation column configured to be used in the chromatography system at an operative value of a mobile phase flow rate of the CO₂-based mobile phase flow stream, and a restrictor matched to the type of chromatography separation column for use together during operation of the chromatography system. The restrictor is configured such that the post-column pressure in the chromatography system during operation is maintained at a target pressure at the operative value of the mobile phase flow rate.

The apparatus 200 includes at least one memory 202 and at least one processing unit 204. The at least one processing unit 204 is communicatively coupled to the at least one memory 202 and also to at least one component of a chromatography system 206.

The at least one memory 202 is configured to store processor-executable instructions 208 and a computation module 210. In an example method as described in connection with FIG. 1A or 1B, the at least one processing unit 204 can execute processor-executable instructions 208 stored in the memory 202 to cause the computation module 220 to transmit to a user, or to display to a display unit, data indicative of the operative value of the mobile phase flow rate of the CO₂-based mobile phase flow stream that corresponds to the chromatography separation column and the target pressure. The computation module also can be used to compute the target pressure based on data indicative of the dimensions and other parameters indicating the type of separation column and the dimensions of the matching restrictor flow rate.

Example systems, methodologies, and apparatus according to the principles herein can provide kits that can used to optimize the sensitivity of a chromatography system. An example kit includes a chromatography separation column configured to be used in the chromatography system at an operative value of a mobile phase flow rate of the CO₂-based mobile phase flow stream, and a restrictor matched to the type of chromatography separation column for use together during operation of the chromatography system. The restrictor is configured such that the post-column pressure in the chromatography system during operation is maintained at a target pressure at the operative value of the mobile phase flow rate. The example kit also includes at least one processing unit that is configured to communicate with at least one component of a chromatography system. The example processing unit can include processor-executable instructions execute processor-executable instructions to transmit to a user, or to display to a display unit, data indicative of the operative value of the mobile phase flow rate of the CO₂-based mobile phase flow stream that corresponds to the chromatography separation column and the target pressure.

An example kit can include, in a bundled package, a separation column, a restrictor matched to the type of the separation column according to the principles described herein, and at least one processing device configured to execute processor-executable instructions to transmit an indication of the values of mobile phase flow rate and post-column pressure that optimizes performance of the chromatography system with this matched combination of restrictor and separation column.

An example kit according to the principles herein can be configured based on a select combination of at least four components—a separation column, at least one restrictor, pressure-controlling pump, and at least one processing device. The example kit is in a bundled package is suitable for a chromatography system configured to operate with a pressure-controlling fluid interface. Each of the at least one restrictor is matched to the type of the separation column according to the principles described herein. The type of the separation column determines the appropriate value of mobile phase flow rate, and the value of the flow rate in turn determines the type of the at least one restrictor that is matched to the separation column. The percentage (%) reduction in restrictor pressure versus a target system pressure is present to allow for the pressure-controlling fluid flow rate to span the difference between the restrictor pressure and the target system pressure. The pressure-controlling fluid pump uses a control loop to deliver the appropriate fluid flow rate through the restrictor such that the chromatography system remains at the target system pressure, i.e., the pressure-controlling fluid pump operates in a constant-pressure mode.

In an example kit, the processing unit can further execute processor-executable instructions to cause the chromatography system to maintain the post-column pressure at the target pressure during operation.

In an example kit where the restrictor is configured such that a post-column pressure in the chromatography system during operation is a value above which the CO₂-based mobile phase flow stream is in a relatively incompressible state, the at least one processing unit can be further configured to execute processor-executable instructions to cause the post-column pressure in the chromatography system during operation to be at a value above which the CO2-based mobile phase flow stream is in a relatively incompressible state.

In some embodiments, the target pressure post-column is designed to be held constant over a composition gradient. In certain embodiments, the matching restrictor is designed to allow pressure to be modulated to maintain constant average pressure on the column over a composition gradient. In certain embodiments, the system is designed to execute a pressure-programmed gradient separation with a neat CO₂ mobile phase.

At least one processing unit of the example kit can be programmed further to execute processor-executable instructions to cause the CO₂-based mobile phase flow stream to flow at the specified value of the mobile phase flow rate.

In an example, the example kit further includes at least one memory to store the processor-executable instructions, where the at least one processing unit is communicatively coupled to the at least one memory.

An example kit also can include an apparatus 200 as shown in FIG. 2 to perform the processes and computations described herein. For example, the at least one processing unit 204 of apparatus 200 can be programmable to execute the processor-executable instructions 208 stored in the memory 202 to cause the computation module 220 to transmit to a user, or to display to a display unit, data indicative of the operative value of the mobile phase flow rate of the CO₂-based mobile phase flow stream that corresponds to the chromatography separation column and the target pressure. The data 212 can include the data indicative of the operative value of the mobile phase flow rate of the CO₂-based mobile phase flow stream that corresponds to the chromatography separation column and the target pressure.

The data for the operative value of the mobile phase flow rate and/or the target pressure can be computed based on measurement data from the desired performance range of a set of chromatography systems that include known restrictor components, known separation columns, for known values of mobile phase flow rate and mixed mobile phase composition set to known values. Measurement data indicative of the performance of the chromatography systems can be collected for each run of a chromatography system that includes each of the series of restrictor components and separation columns at the known conditions. As an example, the chromatography system can include one or more sensors to measure the flow rate and/or pressure to provide the measurement data used for computing the operative value of the mobile phase flow rate and/or the target pressure.

The example systems, methodologies, and apparatus, including the kits, described herein are applicable to many different types of chromatography systems that include at least one restrictor component. While the example systems, methodologies, apparatus and kits are described herein relative to certain types and configurations of chromatography systems, they apply to many different types of chromatography systems, such as but not limited to supercritical fluid chromatography (SFC) systems (including but not limited to UltraPerformance Convergence Chromatography™ (UPC²™) chromatography systems available from Waters Corporation, Milford, Mass.), high performance liquid chromatography (HPLC) systems, ultra-high performance liquid chromatography (UHPLC), gas chromatography (GC) systems, dense GC systems, solvating GC separation systems, and supercritical fluid extraction (SFE) systems.

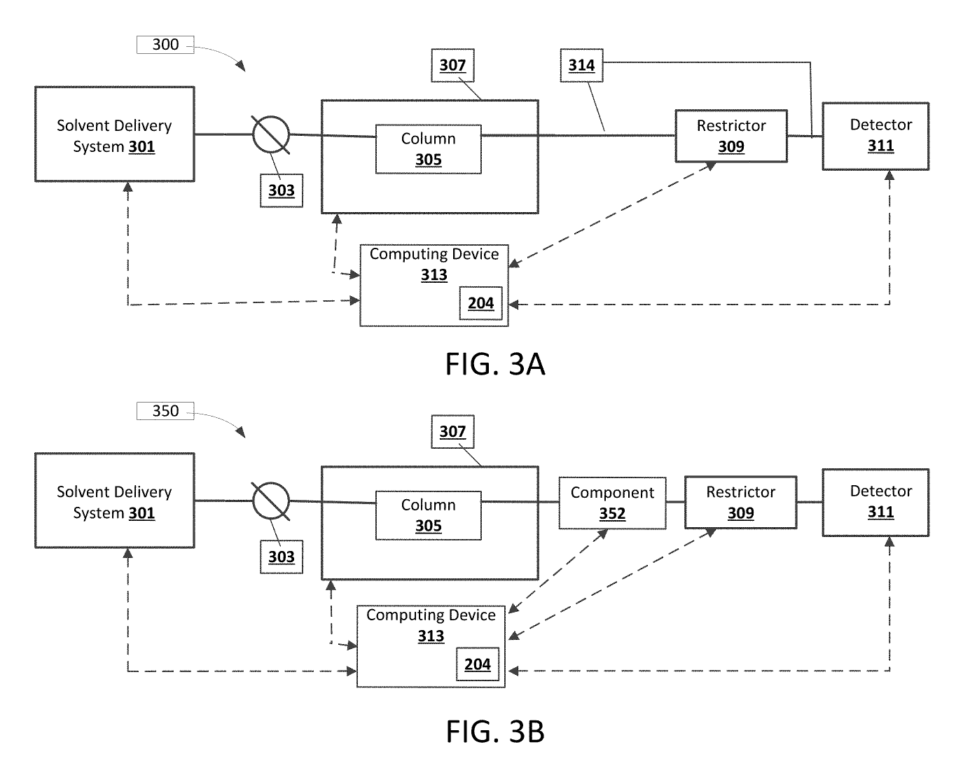

FIG. 3A is a block diagram illustrating an example CO₂-based chromatography system 300 including a restrictor component. In this example, a solvent delivery system 301 including one or more pumps (not shown) is used to draw a CO₂ mobile phase from a CO₂ container, through a sample injector 303, to the chromatography column 305 (located within a column oven 307). A restrictor 309 is located downstream of the chromatography column 307 and upstream of a detector 311. Fluidically coupled to the solvent delivery system 301 are one or more sources of solvents that are used during the course of a chromatographic run. From these sources of solvent, the solvent delivery system 301 draws a mobile phase fluid (which also can be referred to as a compressible mobile phase fluid) and moves the mobile phase to the sample injector 303. The chromatographic separation occurs under predetermined pressure conditions, which are either static or programmed dynamic pressure conditions. The solvent delivery system 301 can operate in a constant-pressure mode or in a constant-flow mode. In the constant-pressure mode, the solvent delivery system 301 produces the system pressure in the chromatography system 300 with one or more pumps (not shown) in accordance with, for example, a density program. The restrictor 309 can be used to control the mobile phase flow rate when the solvent delivery system 301 is in the constant-pressure mode. When in the constant-flow mode, the system 300 provides a set mass flow rate or set volumetric flow rate of solvent. This flow rate can be programmable. When the solvent delivery system 301 is in the constant-flow mode, the restrictor 309 can be used to control the system pressure.

The sample injector 303 is in fluidic communication with a sample source from which the sample injector 303 acquires a sample (i.e., the material under analysis) and introduces the sample to the mobile phase arriving from the solvent delivery system 301. Non-limiting examples of samples include complex mixtures of proteins, protein precursors, protein fragments, reaction products, small molecules and other compounds.

The chromatography column 307 is adapted to separate the various components (or analytes) of the sample from each other at different rates as the mobile phase passes through, and to elute the analytes (still carried by the mobile phase) from the chromatography column 307 at different times. Non-limiting examples of the chromatography column 307 include a variety of sizes (e.g., preparative, semi-preparative, analytical-scale (e.g., 4.6 mm ID), or capillary-scale packed-bed columns or open tubular columns) and a variety of preparations, such as but not limited to is metallic, fused silica, or polymeric tubes, or in metallic, ceramic, silica, glass, or polymeric microfluidic platforms or substrates of various internal dimensions. Packed columns contain packing media of various diameter, porosity, and functionality.

As shown in FIG. 3A, a computing device 313 including at least one processing unit 204 (shown in FIG. 2) is configured to communicate with at least one component of the chromatography system. For example, the computing device 313 can be configured to communicate with one or more of the solvent delivery system 301, the column oven 307, or the detector 311. The computing device may also be configured to communicate with one or more components disposed at either or both regions 314 of the chromatography system, such as but not limited to one or more pressure-controlling components, one or more sensors, and/or one or more meters (such as but not limited to a low-volume flow meter).

In examples, data, and/or commands for control, and/or instructions can be communicated between the computing device 313 and at least one component of the chromatography system. For example, the computing device 313 can be used to execute processor-executable instructions to control the pressure, and/or temperature, and/or mobile phase flow rate, and/or mobile phase composition in one or more components of the chromatography system, based on the operative value of the mobile phase flow rate and/or the target pressure for the known separation column and matching restrictor component. As another example, the computing device 313 can be used to execute processor-executable instructions to run a density program by which the computing device 313 controls the system pressure produced by the solvent delivery system 301 during the course of the chromatographic run, or run a gradient schedule by which the computing system 313 controls the mobile phase composition produced by the solvent delivery system 301. As yet another example, the computing device 313 can be used to execute processor-executable instructions to control the temperature of a component of the chromatography system, such as but not limited to the column oven 307 and/or the restrictor 309.

The example detector 311 can be a gas chromatography type detector, such as but not limited to a flame ionization detector (FID) and a mass spectrometer. Other example detectors 311 include, but are not limited to, a mass spectrometer and an evaporative light scattering detector. The output of the detector 311 depends on the type of detector, and can be, for example, a voltage signal or a current that is applied, for example, to an X-Y plotter or some type of chart recorder, which graphs the detector output over time, or is supplied as input to a data system, such as included in computing device 313. Other types of detectors can be used in connection with the restrictors described herein.

The computing device 313 including the at least one processing unit 204 can be used to execute the example processes and computations described herein. The computing device 313 can include at least one apparatus 10 described hereinabove. An example kit as described herein that includes a restrictor and the at least one processing unit may be coupled with the example chromatography system to provide the system shown in FIG. 3A. For example, the restrictor of the kit may be used to substitute the restrictor of an existing chromatography system having a separation column determined to match with the restrictor, and the at least one processing device may be used to execute the processes and computations described herein.

As shown in FIG. 3A, the example chromatography system 300 can include one or more additional components in either or both regions 314. FIG. 3B shows an example chromatography system 350 that includes at least one additional component 352 along with the other components described hereinabove in connection with FIG. 3A. The description of components and features in connection with FIG. 3A also apply to the equivalent components and features shown in FIG. 3B. In this example, the additional component 352 is positioned downstream of the chromatography column 305 and upstream of the restrictor 309. In other example, the additional component 352 can be positioned downstream of the restrictor 309 and upstream of the detector 311, or additional components 352 could be disposed in both positions. As non-limiting examples, additional component 352 can be, but is not limited to, a pressure-controlling fluid pump, one or more sensors, one or more backpressure regulators (or other pressure-controlling components or interface), one or more meters (such as but not limited to low-volume flow meters), or splitters. The one or more sensors can be used for measuring parameters such as but not limited to system pressure, gradient composition, temperature of the mobile phase, and mass flow rate. As shown in FIG. 3B, the computing device 313 including at least one processing unit 204 also can be configured to communicate with the additional component 352.

In any of the example systems, methodologies, apparatus or kits herein, the at least one processing unit 204 is communicatively coupled to the at least one memory 202 and also to at least one component of a chromatography system (including chromatography system 206), to transmit and/or receive measurement data (such as but not limited to flow rate data, pressure data, and/or temperature data), perform database queries, and implement any other processes described herein, including the processes described in connection with any one or more of FIG. 1A-1B, 2, 3A, or 3B.

In any of FIGS. 1A through 3B, the CO₂-based mobile phase may include a modifier in addition to the CO₂.

Example systems, methodologies, and apparatus according to the principles herein also provide an integrated microfluidic separation device. The example integrated microfluidic separation device includes a chromatography system with independent control of system pressure and flow rate of a CO₂-based mobile phase flow stream and a chromatography system. The example chromatography system includes a chromatography separation column, and a restrictive element matched to the type of the chromatography separation column. The restrictor is configured such that a post-column pressure in the chromatography system during operation is a value of target pressure above which the CO₂-based mobile phase flow stream is in a relatively incompressible state. The example integrated microfluidic separation device also includes at least one processing unit configured to execute processor-executable instructions to transmit to a user, or display to a display unit, data indicative of the value of target pressure and a specified value of a mobile phase flow rate of the CO₂-based mobile phase flow stream that corresponds to the chromatography separation column.

In an example, the integrated microfluidic separation device further includes at least one memory to store the processor-executable instructions, where the at least one processing unit is communicatively coupled to the at least one memory.

In an example, the integrated microfluidic separation device further includes an inlet port for a pressure-controlling fluid.

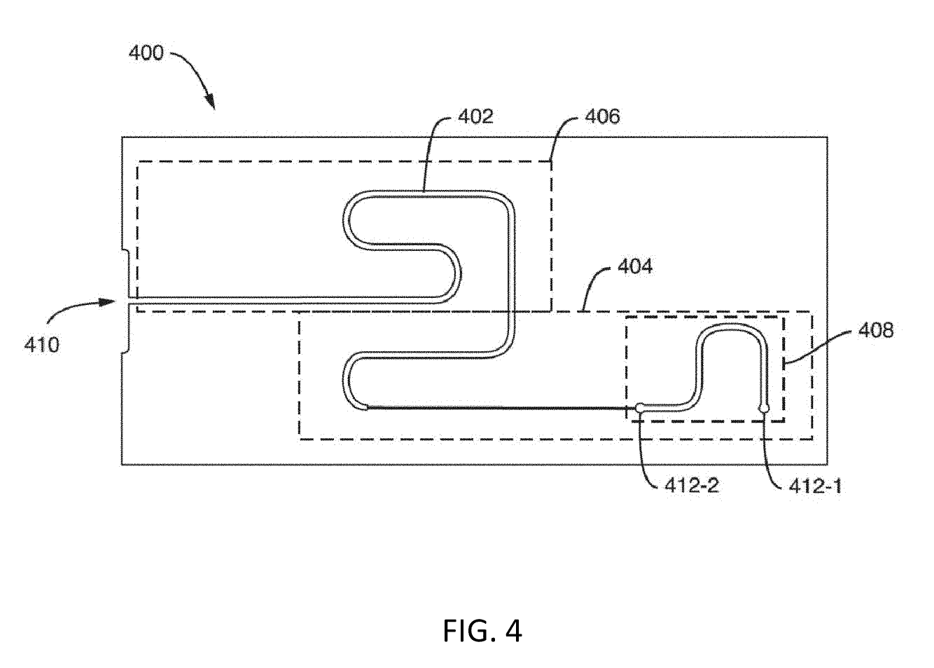

FIG. 4 shows an example microfluidic substrate (or tile) 400 used to implement an example of a matching restrictor body. The microfluidic substrate 400 is generally rectangular, flat, and thin (approx. 0.050″) and has a multilayer construction. Example construction materials for the microfluidic substrate 400 include metallic (e.g., titanium, stainless steel), ceramic, glass, and polymeric. For protein samples, the microfluidic substrate 400 is preferably a High-Temperature Co-fired Ceramic (HTCC), which provides suitably low levels of loss of sample because of attachment of sample to walls of conduits in the substrate. Example implementations of microfluidic substrates are described in U.S. application Ser. No. 12/282,225, filed Mar. 19, 2007, titled “Ceramic-based Chromatography Apparatus and Methods for Making Same,” and published as US2009-0321356, the entirety of which is incorporated herein by reference. The microfluidic substrate 400 can be housed in a microfluidic cartridge, such as described in International application no. PCT/US2010/026342, filed Mar. 5, 2010, titled “Electrospray Interface to a Microfluidic Substrate,” the entirety of which is incorporated herein by reference.

Formed within the layers of the example microfluidic substrate 400 is a serpentine fluidic channel 402 for transporting the mobile phase. The fluidic channel 402 can be, for example, lasered, etched, embossed, or machined into the substrate layers. The fluidic channel 402 passes through two regions of the microfluidic substrate 400, including a column region 404 and a restrictor body region 406. The column region 404 can include a trap region 408. Apertures 412-1 and 412-2 open into the fluidic channel 402 at opposite ends of the trap region 408. The fluidic aperture 412-2 at the “downstream” end of the trap region 408 is optionally used as a fluidic outlet aperture, for example, during loading of the trap region 408, and is optionally closed to fluid flow, for example, during injection of a loaded sample from the trap region 408 into the fluidic channel 402.

The fluidic channel 402 terminates at an opening 410 in an edge of the microfluidic substrate 400. A restrictor tip, such as any of the matching restrictors described herein (including in connection with any of FIGS. 1-7 herein), can be brought into fluidic communication with this opening 410 to restrict the flow of the mobile phase flowing through the fluidic channel 402. Techniques for interfacing a restrictor tip to an opening at the edge of a microfluidic substrate 400 are described in the aforementioned International application no. PCT/US2010/026342.

Alternatively, the fluidic channel 402 can terminate at an opening in a side of the substrate 400. Other types of restrictor tips can be integral to the microfluidic substrate, for example, a frit can be embedded into the microfluidic substrate at the egress end of the fluidic channel 402, or the opening 410 can be fashioned to be smaller than the ID of the fluidic channel 402. In contrast to the externally attached restrictor tips, the integral restrictors cannot be removed and replaced. The sizes of the regions 404, 406, 408, and the shape and length of the fluidic channel 402 within each region, are merely illustrative examples. Other examples of microfluidic platforms 400 can have the restrictor body region 406 and column region 404 on different interconnected tiles, similar to that illustrated in the aforementioned International application no. PCT/US2010/026342.

The restrictor body and column regions 404, 406, whether implemented on the same or on different substrates, can be independently controlled thermal regions.

The pressure-controlling fluid can be introduced after the column region 404 and upstream of the restrictive element 402.

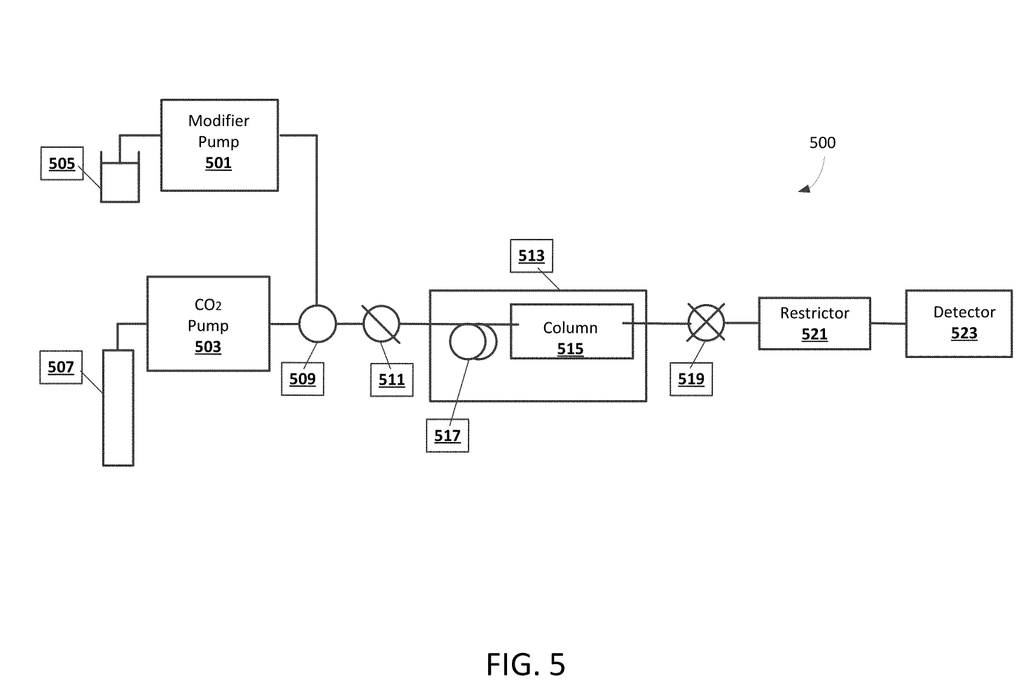

Non-limiting examples of variations of chromatography systems that can be implemented using the separation column and include at least one matching restrictor, and operated at the operative value of the mobile phase flow rate and/or the target pressure according to the principles herein, are described in connection with the non-limiting examples of FIGS. 5-7 hereinbelow. The description of components and features of the chromatography systems in connection with FIGS. 3A and 3B also apply to the equivalent components and features described in connection with FIGS. 5-7. The application of the example systems, methodologies, apparatus, and kits as described herein in connection with any of FIGS. 1A through 3B also can be applied to the non-limiting example chromatography systems of FIGS. 5-7, as described in greater detail below. Furthermore, the components and features of any of the chromatography systems of FIGS. 5-7 can be formed as an integrated microfluidic separation device, or integrated with a microfluidic separation device, as described in connection with FIG. 4 hereinabove. The application of the example systems, methodologies, apparatus, and kits as described herein in connection with any of FIGS. 5-7 can be applicable to an integrated microfluidic separation device as described in connection with FIG. 4 hereinabove.

FIG. 5 is a block diagram illustrating an example CO₂-based chromatography system 500 including a restrictor component, which is configured as a full-flow CO₂-based chromatography system. This example chromatography system 500 illustrates an example architecture of a solvent delivery system for mixing a modifier with the CO₂, such as but not limited to a modifier (e.g., methanol) or a ternary additive (e.g., pH controllers)). As shown in FIG. 5, a modifier pump 501 is used to pump a liquid modifier from a solvent reservoir 505 to a chromatography column 515 through a mixer 509 and an injector 511. In parallel to the modifier pump 501, a CO₂ pump 503 is used to pump CO₂ from a CO₂ container 507 to the chromatography column 515 through the mixer 509 and injector 511. In this example, the column 515 is located within a column oven 513, which includes preheating elements 517. A pressure-controlling component 519 (such as but not limited to a backpressure regulator (BPR)) is located at the output of the chromatography column 515. The pressure-controlling component 519 can be used to control pressure within the column 515. A restrictor 521 is located downstream of the pressure-controlling component 519 and upstream of a detector 523. In some embodiments, a post-column addition pump or makeup fluid pump is used to aid in transporting analytes through the restrictor 521 and assuring CO₂ and co-solvent miscibility. The addition of liquid can help to transport the analyte to detection, such as when operating with low percentages of co-solvent.

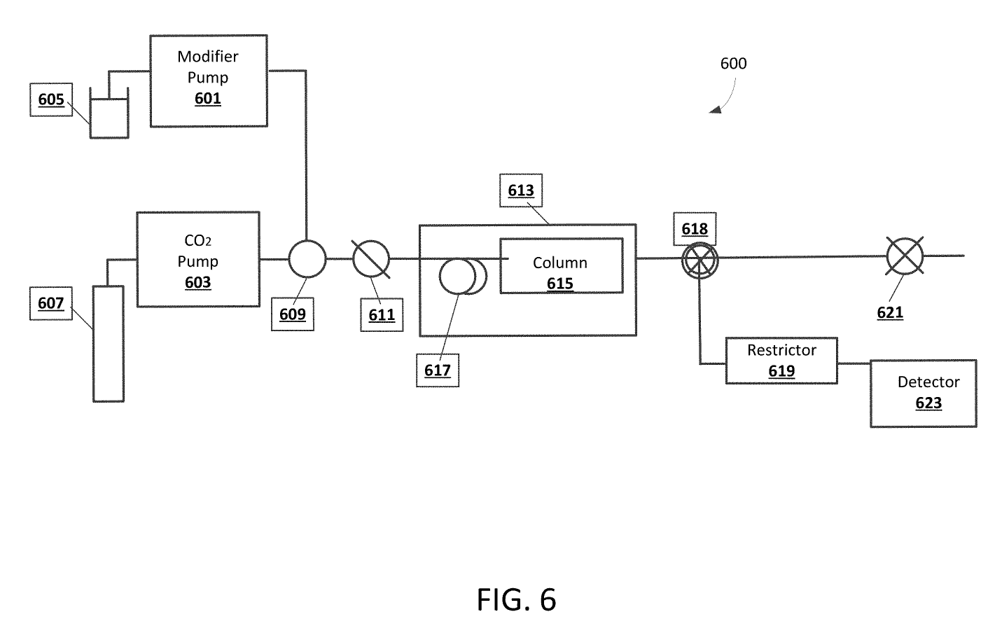

FIG. 6 is a block diagram illustrating an example CO₂-based chromatography system 600 including a restrictor component, which is configured as a split-flow CO₂-based chromatography system. This example chromatography system 600 illustrates an example architecture of a solvent delivery system for mixing a modifier with the CO₂, such as but not limited to a modifier (e.g., methanol) or a ternary additive (e.g., pH controllers)). As shown in FIG. 6, a modifier pump 601 is used to pump a liquid modifier from a solvent reservoir 605 to a chromatography column 615 through a mixer 609 and injector 611. The modifier pump 601, a CO₂ pump 603 is used to pump CO₂ from a CO₂ container 607 to the chromatography column 615 through the mixer 609 and injector 611. In this example, the column 615 is located within a column oven 613, which includes preheating elements 617. The example chromatography system 600 achieves the splitting using a tee fitting 618 and a restrictor 619 in the mobile phase stream. The tee fitting 618 routes a majority portion of the mobile phase flow to a pressure-controlling component 621 for maintaining and controlling system pressure. Non-limiting examples of the pressure-controlling component 621 include a BPR, a fixed restrictor, a thermally modulated variable restrictor, or other system pressure regulator. The restrictor 619 routes a portion of the total mobile phase flow rate to the detector 623 for detection. The split-flow chromatography system 600 differs from the system described in reference to FIG. 5 in that the detector 623 is split from the pressure-controlling component 621. In this example, the mobile phase retains appreciable solvating power until the analyte is within the detector 623. The split-flow interface provides additional capabilities for controlling the interface between the chromatography system with a pressure-controlling component 621 to a low-pressure detector 623. With the use of a fixed restrictor, a change to the system pressure or mobile phase viscosity can result in a change in the split ratio, which can interfere with quantitation.

One or more sensors can be disposed at various points in the mobile phase streams, e.g., downstream of the chromatography column 615. For example, a sensor disposed between the chromatography column 615 and the tee fitting 618 can be a pressure transducer that measures the system pressure before the stream of mobile phase is split. Alternatively, a sensor such as a viscometer or densitometer can be configured to measure the composition of the mobile phase. Such measurements can be used to detect changes in the chromatographic run, for example, those pressure changes corresponding to a density program or mobile phase composition changes corresponding to a composition gradient. As another example, a first sensor may be disposed in the main mobile phase flow between the tee fitting 618 and the pressure-controlling component 621 to measure the total mass flow rate, and a second sensor may be disposed in the minority mobile phase stream between the restrictor 619 and the detector 623 to measure the mass flow rate of the minority portion. The split ratio can be determined from the ratio of these flow rates.

The example of FIGS. 1A-1B can apply to a chromatography system that includes two (or more) restrictors, each disposed in parallel to control a split. Either restrictor can be replaced using the matching restrictors in a kit described herein based on the known separation column of the chromatography system, and the operative value of the mobile phase flow rate and/or the target pressure for the matching restrictor.

The example systems, methodologies, apparatus and kits described herein can be used in a chromatography system that includes two pressure-controlling components. In such as example, employing an additional (secondary) pressure regulation device or pressure control element in a CO₂-based chromatography system allows for efficient full-flow introduction of the mobile phase stream to a low-pressure detector when using a back pressure regulator. The secondary pressure control device ensures mobile phase density all the way into the detector, thereby preventing phase separation and analyte precipitation, which may occur without a secondary pressure control device.

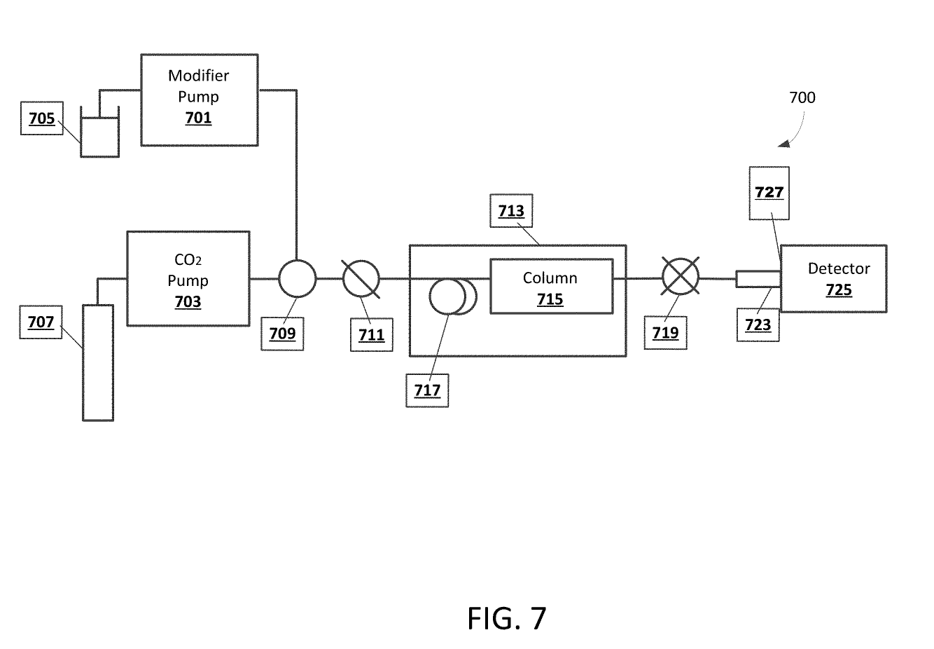

FIG. 7 is a block diagram illustrating an example CO₂-based chromatography system 700 including a restrictor component, which includes a secondary pressure control device. Modifier pump 701 is used to pump a liquid modifier from a solvent reservoir 705 to a chromatography column 715 through a mixer 709 and injector 711. A CO₂ pump 703 is used to pump CO₂ from a CO₂ container 707 to the chromatography column 715 through the mixer 709 and injector 711. The column 715 is located within a column oven 713. The column oven 713 includes preheating elements 717 used for heating and controlling the temperature of the mobile phase entering the column 715. A primary pressure control element 719 is located downstream of the column 715. A secondary pressure control element 723 is located downstream of the primary pressure controlling element 719 and upstream of a detector 725. In a non-limiting example, the primary pressure control element 719 can be a BPR. The primary pressure control element 719 can be used to control pressure of the mobile phase within the column 715.

In some examples, the secondary pressure control device 723 is located as close as possible to the point of detection inside the detector 725. In a non-limiting example, the point of detection is the flame inside a FID or the electrospray ionization spray plume inside a mass spectrometer (MS). In one embodiment, the outlet of the secondary pressure control element 727 can be located within about 5.0 cm from the inlet of the detector 723. In some embodiments, the outlet 727 of the secondary pressure control element 723 is located within about 2.5 cm from the inlet of the detector 725. In certain embodiments the outlet 727 is within 1 cm or less of the inlet to detector 725. The secondary pressure control element 723 can be, for example, a restrictor, a back pressure regulator, or a variable restrictor (such as but not limited to a thermally modulated variable restrictor). This example shows a secondary pressure control device 723 incorporated into a full-flow CO₂-based chromatography system. The secondary pressure control device 723 provides for increased CO₂/co-solvent miscibility and improved analyte transport from the primary pressure control element 719 to the detector 723. The secondary pressure control device 723 addresses the limitations encountered with interfacing CO₂-based chromatography to detection and helps prevent phase separation while transporting the analyte from the primary pressure control device 719 to the detector 723.

In a non-limiting example, both the primary pressure control element 719 and the secondary pressure control element 723 can be BPRs.

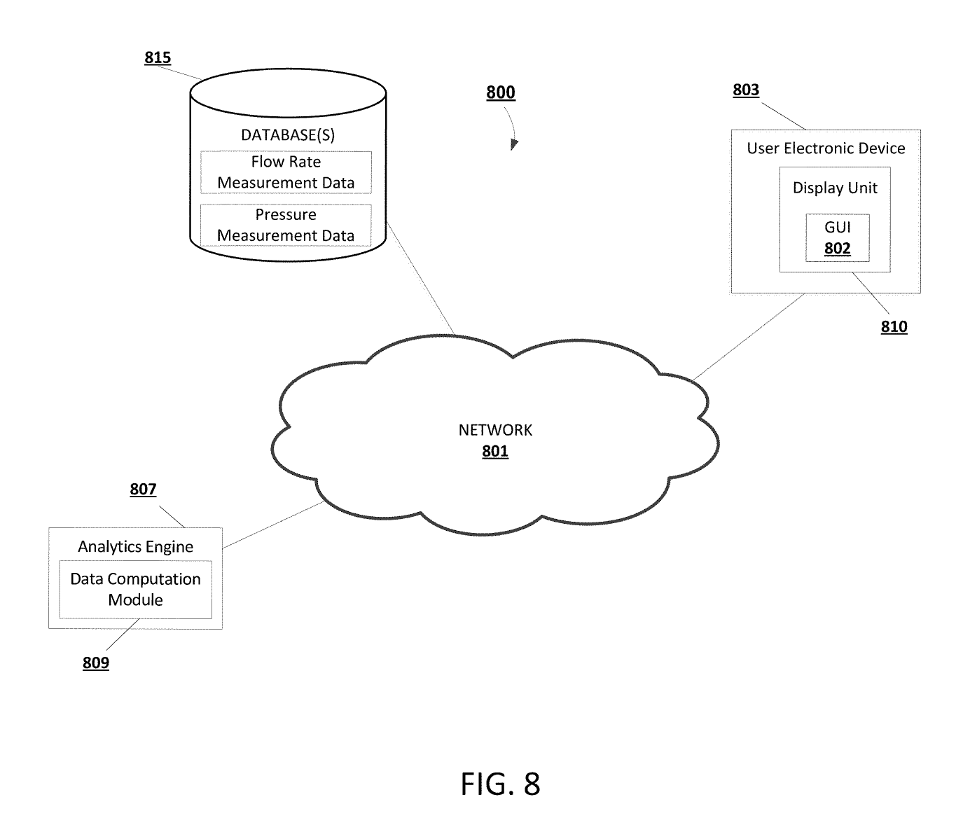

FIG. 8 illustrates a network diagram depicting a system 800 suitable for a distributed implementation of example systems described herein. The system 800 can include a network 801, a user electronic device 803, an analytics engine 807, and a database 815. As will be appreciated, the analytics engine 807 can be local or remote servers, and various distributed or centralized configurations may be implemented, and in some embodiments a single server can be used. In exemplary embodiments, the analytics engine 807 can include one or more modules 809, which can implement one or more of the processes described herein, or portions thereof, with reference to any one or more of FIGS. 1A-7. For example, the analytics engine 807 can include a data computation module 809 configured to perform one or more of the processes and computations described in connection with any one or more of FIGS. 1A-7. The user electronic device 803 and analytics engine 807 can communicate with each other and with the database 815 and at least one component of the chromatography system (as described above relative to FIGS. 1A-7) to transmit and receive measurement data (such as but not limited to flow rate data, and/or pressure data, and/or temperature data), perform database queries, and implement the processes described above.

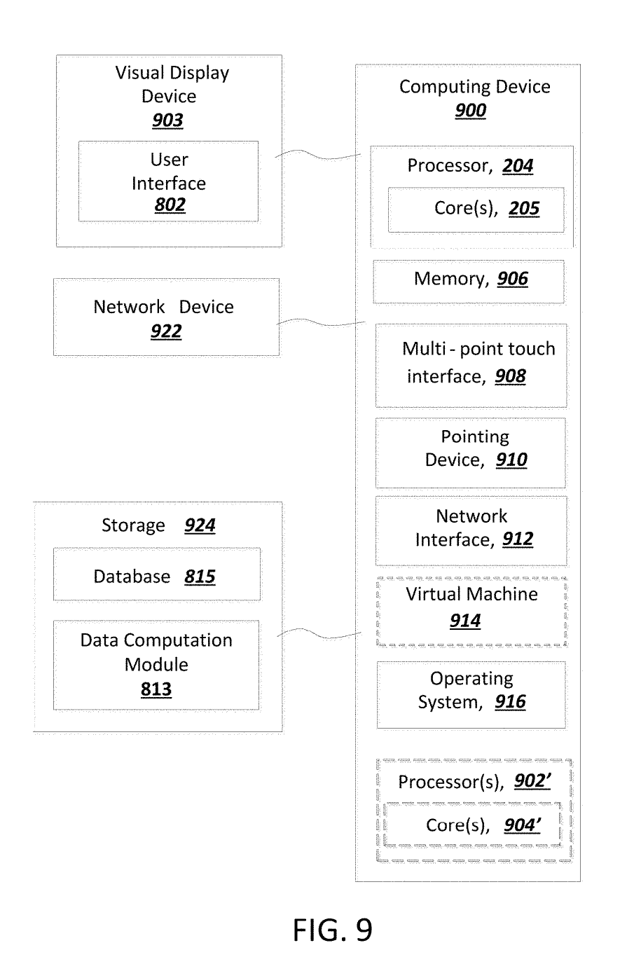

In exemplary embodiments, the user electronic device 803 may include a display unit 810, which can display a GUI 802 to a user of the device 803 such that the user can view the rendered graphic icon, visual display, or type of other signal used to indicate the operative value of a mobile phase flow rate and/or target pressure for a matching restrictor, as described above. The user electronic device 803 may include, but is not limited to, smart phones, tablets, ultrabooks, netbooks, laptops, computers, general purpose computers, Internet appliances, hand-held devices, wireless devices, portable devices, wearable computers, cellular or mobile phones, portable digital assistants (PDAs), desktops, multi-processor systems, microprocessor-based or programmable consumer electronics, game consoles, set-top boxes, network PCs, mini-computers, smartphones, tablets, netbooks, and the like. The user electronic device 803 may include some or all components described in relation to computing device 900 shown in FIG. 9. The user electronic device 803 may connect to network 801 via a wired or wireless connection. The user electronic device 803 may include one or more applications such as, but not limited to, a web browser, a sales transaction application, an object reader application, and the like.

In exemplary embodiments, the user can interact with the user electronic device 803 using a keyboard, mouse, gamepad controller, voice commands, or non-touch gestures recognizable by the user electronic device. In alternative embodiments, the user electronic device 803 can be a mobile device, such as a smartphone, or tablet.

In exemplary embodiments, the user electronic device 803, analytics engine 807, and database 815 may be in communication with each other via a communication network 801. The communication network 801 may include, but is not limited to, the Internet, an intranet, a LAN (Local Area Network), a WAN (Wide Area Network), a MAN (Metropolitan Area Network), a wireless network, an optical network, and the like. In one embodiment, the user electronic device 803, and analytics engine 807 can transmit instructions to each other over the communication network 801. In exemplary embodiments, the flow rate measurement data, pressure measurement data, and other data (including temperature data) can be stored at database 815 and received at the analytics engine 807.

In general, system 800 can identify the column/restrictor package installed and automatically set the appropriate mobile phase flow rate and its target pressure (i.e., uses NFC, RFID, barcode, pins, resistor values, or any other mechanical/electrical devices).

FIG. 9 is a block diagram of an exemplary computing device 900 that can be used in the performance of any of the example methodologies according to the principles described herein (including example methodologies associated with any one or more of FIGS. 1A-7). The computing device 900 includes one or more non-transitory computer-readable media for storing one or more computer-executable instructions (such as but not limited to software or firmware) for implementing any example method according to the principles described herein (including example methodologies associated with any one or more of FIGS. 1A-7). The non-transitory computer-readable media can include, but are not limited to, one or more types of hardware memory, non-transitory tangible media (for example, one or more magnetic storage disks, one or more optical disks, one or more USB flashdrives), and the like.

For example, memory 906 included in the computing device 900 can store computer-readable and computer-executable instructions or software for implementing exemplary embodiments and programmed to perform processes described above in reference to any one or more of FIGS. 1A-7 (including processor-executable instructions 208). The computing device 900 also includes processing unit 204 (and associated core 205), and optionally, one or more additional processor(s) 902′ and associated core(s) 904′ (for example, in the case of computer systems having multiple processors/cores), for executing computer-readable and computer-executable instructions or software stored in the memory 906 and other programs for controlling system hardware. Processing unit 204 and processor(s) 902′ can each be a single core processor or multiple core (205 and 904′) processor.

Virtualization can be employed in the computing device 900 so that infrastructure and resources in the computing device can be shared dynamically. A virtual machine 914 can be provided to handle a process running on multiple processors so that the process appears to be using only one computing resource rather than multiple computing resources. Multiple virtual machines can also be used with one processor.

Memory 906 can be non-transitory computer-readable media including a computer system memory or random access memory, such as DRAM, SRAM, EDO RAM, and the like. Memory 906 can include other types of memory as well, or combinations thereof.

A user can interact with the computing device 900 through a visual display device 903, such as a touch screen display or computer monitor, which can display one or more user interfaces 802 that can be provided in accordance with exemplary embodiments. The computing device 900 can also include other I/O devices for receiving input from a user, for example, a keyboard or any suitable multi-point touch interface 908, a pointing device 910 (e.g., a pen, stylus, mouse, or trackpad). The keyboard 908 and the pointing device 910 can be coupled to the visual display device 903. The computing device 900 can include other suitable conventional I/O peripherals.

The computing device 900 can also include one or more storage devices 924, such as a hard-drive, CD-ROM, or other non-transitory computer readable media, for storing data and computer-readable instructions and/or software, such as a data computation module 809 that can implement exemplary embodiments of the methodologies and systems as taught herein, or portions thereof. Exemplary storage device 924 can also store one or more databases 815 for storing any suitable information required to implement exemplary embodiments. The databases can be updated by a user or automatically at any suitable time to add, delete, or update one or more items in the databases. Exemplary storage device 924 can store one or more databases 815 for storing flow rate measurement data, pressure measurement data, and any other data/information used to implement exemplary embodiments of the systems and methodologies described herein.

The computing device 900 can include a network interface 912 configured to interface via one or more network devices 922 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 912 can include a built-in network adapter, network interface card, PCMCIA network card, card bus network adapter, wireless network adapter, USB network adapter, modem or any other device suitable for interfacing the computing device 900 to any type of network capable of communication and performing the operations described herein. Moreover, the computing device 900 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 900 can run any operating system 916, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 916 can be run in native mode or emulated mode. In an exemplary embodiment, the operating system 916 can be run on one or more cloud machine instances.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes a plurality of system elements, device components or method steps, those elements, components or steps can be replaced with a single element, component or step. Likewise, a single element, component or step can be replaced with a plurality of elements, components or steps that serve the same purpose. Moreover, while example embodiments have been shown and described with references to particular embodiments thereof, those of ordinary skill in the art will understand that various substitutions and alterations in form and detail can be made therein without departing from the scope of the disclosure. Further still, other aspects, functions and advantages are also within the scope of the disclosure.

Example flowcharts are provided herein for illustrative purposes and are non-limiting examples of methodologies. One of ordinary skill in the art will recognize that example methodologies can include more or fewer steps than those illustrated in the example flowcharts, and that the steps in the example flowcharts can be performed in a different order than the order shown in the illustrative flowcharts.

In alternative embodiments, the techniques described above with respect to pumps used in CO₂-based chromatography systems may be applicable to pumps used in other types of chromatography systems that include mobile phases that vary greatly in density with minor changes in temperature (and/or pressure). For example, a mobile phase including methanol at extremely high pressures may in some instances benefit from added temperature control. In describing certain example, specific terminology is used for the sake of clarity. For purposes of description, each specific term is intended to at least include all technical and functional equivalents that operate in a similar manner to accomplish a similar purpose. Additionally, in some instances where a particular example embodiment includes a plurality of system elements, device components or method steps, those elements, components or steps may be replaced with a single element, component or step. Likewise, a single element, component or step may be replaced with a plurality of elements, components or steps that serve the same purpose. Moreover, while example embodiments have been shown and described with references to particular embodiments thereof, those of ordinary skill in the art will understand that various substitutions and alterations in form and detail may be made therein without departing from the scope of the invention. Further still, other aspects, functions and advantages are also within the scope of the disclosure.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be examples and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that inventive embodiments may be practiced otherwise than as specifically described. Inventive embodiments of the present disclosure are directed to each individual feature, system, article, material, kit, and/or method described herein. In addition, any combination of two or more such features, systems, articles, materials, kits, and/or methodologies, if such features, systems, articles, materials, kits, and/or methodologies are not mutually inconsistent, is included within the inventive scope of the present disclosure.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification, unless clearly indicated to the contrary, should be understood to mean “at least one.”

The phrase “and/or,” as used herein in the specification, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. Method for configuring a chromatography system with independent control of system pressure and flow rate of a carbon dioxide (CO₂)-based mobile phase flow stream, comprising:
determining a type of chromatography separation column to be used in the chromatography system;
determining an operative value of a mobile phase flow rate of the CO₂-based mobile phase flow stream that corresponds to the chromatography separation column;
determining a matching restrictor to the type of chromatography separation column for use together during operation of the chromatography system, the matching restrictor being configured such that a post-column pressure in the chromatography system during operation is maintained at a target pressure at the operative value of the mobile phase flow rate; and
bundling the chromatography separation column with its matching restrictor for distribution together as a single unit.

2. The method of claim 1, wherein the target pressure is above about 1800 PSI.

3. The method of claim 1, further comprising separating a sample carried by flow of the CO₂-based mobile phase flow stream into analytes.

4. The method of claim 1, wherein the chromatography system comprises a pressure-controlling fluid interface.

5. The method of claim 4, wherein the chromatography system is a pure-CO₂ pressure-programmed gradient system, and wherein the target pressure is the lowest initial pressure of the chromatography system.

6. The method of claim 1, wherein the CO₂-based mobile phase flow stream further comprises a modifier, a ternary additive, or a combination of one or more modifiers and one or more ternary additives.

7. The method of claim 1, wherein the matching restrictor is configured such that a post-column pressure in the chromatography system during operation is a value above which the CO₂-based mobile phase flow stream is in a relatively incompressible state.

8. The method of claim 7, wherein the CO₂-based mobile phase flow stream provides for a specified threshold CO₂-modifier miscibility.

9. The method of claim 7, wherein the CO₂-based mobile phase flow stream comprises a methanol modifier, and wherein the matching restrictor provides an outlet pressure ranging from about 10% to about 20% lower than a target value of a post-column pressure at a proportion of about 30% of the methanol modifier to the CO₂-based mobile phase flow stream.

10. A kit for a chromatography system with independent control of system pressure and flow rate of a CO₂-based mobile phase flow stream, comprising:
a chromatography separation column configured to be used in the chromatography system at an operative value of a mobile phase flow rate of the CO₂-based mobile phase flow stream;
a restrictor matched to the type of chromatography separation column for use together during operation of the chromatography system, the restrictor being configured such that a post-column pressure in the chromatography system during operation is maintained at a target pressure at the operative value of the mobile phase flow rate; and
at least one processing unit configured to execute processor-executable instructions to transmit to a user, or to display to a display unit, data indicative of the operative value of the mobile phase flow rate of the CO₂-based mobile phase flow stream that corresponds to the chromatography separation column and the target pressure.

11. The kit of claim 10, wherein the at least one processing unit is configured to execute processor-executable instructions to cause the chromatography system to maintain the post-column pressure at the target pressure during operation.

12. The kit of claim 10, wherein the target pressure is above about 1800 PSI.

13. The kit of claim 10, wherein the restrictor is configured such that a post-column pressure in the chromatography system during operation is a value above which the CO₂-based mobile phase flow stream is in a relatively incompressible state.

14. The kit of claim 13, wherein the at least one processing unit is configured to execute processor-executable instructions to cause the post-column pressure in the chromatography system during operation to be at a value above which the CO₂-based mobile phase flow stream is in a relatively incompressible state.

15. The kit of claim 10, wherein the at least one processing unit is configured to execute processor-executable instructions to cause the CO₂-based mobile phase flow stream to flow at the specified value of the mobile phase flow rate.

16. The kit of claim 15, wherein the CO₂-based mobile phase flow stream comprises a methanol modifier, and wherein the restrictor is configured to provide an outlet pressure ranging from about 10% to about 20% lower than a target value of a post-column pressure at a proportion of about 30% of the methanol modifier to the CO₂-based mobile phase flow stream.

17. The kit of claim 10, wherein the CO₂-based mobile phase flow stream provides for a specified threshold CO₂-modifier miscibility.

18. The kit of claim 10, further comprising at least one memory to store the processor-executable instructions, wherein the at least one processing unit is communicatively coupled to the at least one memory.

19. An integrated microfluidic separation device comprising:
a chromatography system with independent control of system pressure and flow rate of a CO₂-based mobile phase flow stream, the chromatography system comprising:
a chromatography separation column;
a restrictive element matched to the type of the chromatography separation column, the restrictor being configured such that a post-column pressure in the chromatography system during operation is maintained at a target pressure at the operative value of the flow rate of the CO₂-based mobile phase flow stream; and
at least one processing unit configured to execute processor-executable instructions to transmit to a user, or display to a display unit, data indicative of the value of target pressure and a specified value of a mobile phase flow rate of the CO₂-based mobile phase flow stream that corresponds to the chromatography separation column.

20. The device of claim 19, further comprising at least one memory to store the processor-executable instructions, wherein the at least one processing unit is communicatively coupled to the at least one memory.
